(19) United States
(12) Patent Application Publication
(10) Pub. No.: US 2023/0234003 A1
(43) Pub. Date: Jul. 27, 2023

(54) SURFACE-FUNCTIONALIZED MOLYBDENUM DISULFIDE MEMBRANES FOR FILTRATION APPLICATIONS

(71) Applicant: THE UNIVERSITY OF CHICAGO, Chicago, IL (US)

(72) Inventors: Chong Liu, Chicago, IL (US); Eli Hoenig, Chicago, IL (US)

(21) Appl. No.: 18/012,078

(22) PCT Filed: Jul. 7, 2021
(86) PCT No.: PCT/US21/40606

§ 371 Date: Dec. 21, 2022

Related U.S. Application Data
(60) Provisional application No. 63/050,566, filed on Jul. 10, 2020.

(51) Int. Cl. B01D 71/02; B01D 67/00; B01D 61/02; C02F 1/44

(52) U.S. Cl. CPC B01D 71/022; B01D 67/0079; B01D 61/025; C02F 1/441; B01D 2323/36

(57) ABSTRACT

Molybdenum disulfide membranes for ionic and/or molecular filtration applications are provided. The membranes have high separation performance, including high water flux and high molecule and/or ion rejection, and do not need to be stored in a hydrated condition in order to enable their reuse. The membranes are based on stacked MoS₂ sheets having small hydrophilic organic functional groups covalently bound thereto.

### CROSS-REFERENCE TO RELATED APPLICATIONS

The present application claims priority to U.S. provisional patent application No. 63/050,566 that was filed Jul. 10, 2020, the entire contents of which are incorporated herein by reference.

### REFERENCE TO GOVERNMENT RIGHTS

This invention was made with government support under 5J-30161-0064A awarded by the Department of Energy. The government has certain rights in the invention.

### BACKGROUND

With global water use intensifying and the effects of climate change increasingly salient, water scarcity has become a primary international concern. In response, communities have turned to sea and brackish water to provide a steady flow of potable water to their constituents. In its current form, however, desalination requires an order of magnitude more energy than freshwater treatment. Membranes occupy a central role in reverse osmosis (RO) filtration of salt water; increasing membrane water permeability and salt selectivity would result in lower energy requirements, fewer processing steps, and an overall reduction in the capital cost of desalination facilities.

Restacked two dimensional (2D) materials, which are assemblies of individual atomically thin sheets with their basal planes lying parallel to each other, comprise a new class of nanofiltration membranes that show great promise as efficient separators of ions and small molecules from water. The high aspect ratios of 2D materials determine the macroscopic geometries of these membranes: laminar structures with nanometer-scale spaces between layers. In a filtration device, water flows through the channels between layers of material with little obstruction, while ions and other small molecules are excluded. Graphene and graphene oxide form the basis for the first molecular sieves but the breadth of constituent materials has grown in recent years to include, among others, boron nitride, MXenes and transition metal dichalcogenides (TMDs) such as WS₂ and MoS₂.

Chemically exfoliated MoS₂ (ce-MoS₂) is a particularly viable candidate for RO desalination. The channel width of restacked ce-MoS₂ is on the appropriate length scale for size-based exclusion of ions while facilitating high water flux. A result of its mild hydrophilicity, water molecules interact weakly with the ce-MoS₂ surface. This weak interaction leads to a higher water flux relative to its strongly hydrophilic graphene oxide counterpart. Furthermore, ce-MoS₂ has greater structural stability relative to graphene oxide; when soaked in water, the interlayer spacing of ce-MoS₂ membranes remains stable at ˜1 nm, whereas graphene oxide membranes swell and easily disintegrate. Recent efforts have demonstrated the viability of horizontally aligned ce-MoS₂ as an RO membrane. (Sun, L., et al., Chem. Commun. 49, 10718-10720 (2013); Hirunpinyopas, W. et al., ACS Nano 11, 11082-11090 (2017); Zheng, S., et al., ACS Nano 11, 6440-6450 (2017); Deng, M., Kwac, K., Li, M., Jung, Y. & Park, H. G. Stability, molecular sieving, and ion diffusion selectivity of a lamellar membrane from two-dimensional molybdenum disulfide. Nano Lett. 17, 2342-2348 (2017).) However, the association between the membrane's hydration dependent structure and filtration performance has remained underexplored.

### BRIEF DESCRIPTION OF THE DRAWINGS

Illustrative embodiments of the invention will hereafter be described with reference to the accompanying drawings, wherein like numerals denote like elements.

FIGS. 1A-1B show schematics of the hydration dependent structure of MoS₂ membranes. FIG. 1A shows that, initially, the hydrated ce-MoS₂ membrane was disordered with mesoporous scale voids between layers. When partially dried, the large voids closed but parts of the membrane restacked to the bulk, decreasing the overall porosity of the membrane (and when completely dried, the membrane was impermeable). FIG. 1B shows acetate-MoS₂ membranes dried without restacking to the impermeable bulk-like structure. This allowed the membrane to rehydrate during testing, leading to consistent interlayer spacing without voids or impermeable regions.

FIGS. 2A-2F show characterization of functionalized MoS₂. FIG. 2A shows XPS spectra in the S2p region for ce-, acetate- and amide-MoS₂. The fraction of functional groups was computed by fitting the spectra with peaks from 1T and 2H MoS₂ phases as well as an S—C contribution. FIG. 2B shows FTIR of MoS₂ samples showing the intramolecular acetate and acetamide stretches near 1500 cm⁻¹, as well as the S—C stretching peak in the gray region FIG. 2C shows XRD displaying the shift in interlayer spacing for dried functionalized MoS₂ and hydrated ce-MoS₂ relative to dried ce-MoS₂. FIG. 2D shows a top-down TEM image of acetate-MoS₂ flakes with the diffraction pattern inset, showing evidence of in-plane hexagonal symmetry. FIG. 2E shows a cross-sectional TEM image of a 40 nm acetate-MoS₂ membrane. FIG. 2F shows a top-down TEM image of a 50 nm acetate-MoS₂ membrane with the diffraction pattern inset, illustrating the random orientations of a thick composite flake stack.

FIGS. 3A-3F show characterization of membrane structure on the micro and mesoporous length scales. FIG. 3A shows a SEM cross-section of 3 μm thick dried ce-MoS₂ membrane displaying relatively small voids between layers. FIG. 3B shows a SEM cross-section of 3 μm freeze dried ce-MoS₂ membrane; relatively large gaps are visible between layers. FIG. 3C shows a SEM cross-section of 2 μm freeze dried acetate-MoS₂ membrane, dried then rehydrated. FIG. 3D show quantification of void height distributions for FIGS. 3A-3C. The shaded region depicts the variability between images (shown in FIGS. 10A-10C). FIG. 3E show XRD characterizing the hydration dependent structure of ce-MoS₂ on the microporous scale. As the membrane dried, the bilayer of water peak decreased in intensity, while the bulk-like peak rose. FIG. 3F shows XRD characterizing the hydration dependent structure of acetate-MoS₂ on the microporous scale, where no bulk-like peak is evident.

FIGS. 4A-4B show membrane separation performance and interlayer spacing during testing. FIG. 4A shows hydration dependent water flux (lower panel) and ion rejection (upper panel) for ce-, acetate- and amide-MoS₂ in 17 mM Na₂SO₄, as well as water flux and ion rejection for acetate- and amide-MoS₂ prepared by drying and rehydrating. FIG. 4B shows XRD spectra of ce-, acetate- and amide-MoS₂ membranes when completely dried (labelled as 1.), in their hydrated state after fabrication (2.), and after testing in a dead-end filtration cell (3.). The XRD spectrum for partially dried ce-MoS₂ shows a bulk-like peak that retains its intensity after testing, whereas no such peak is apparent for functionalized MoS₂, indicating that water can diffuse between the functionalized MoS₂ sheets.

FIGS. 5A-5E shows MD simulations describing the dynamics and structure of water in membranes. FIG. 5A shows an MD simulation snapshot showing water confined in a MoS₂ channel with 12 Å interlayer spacing. FIG. 5B shows a cross section of acetate-MoS₂, with functional groups placed randomly at 0.2 per Mo atom. FIG. 5C shows the diffusion constant of water in ce-, acetate- and amide-MoS₂ channels as a function of interlayer spacing. FIG. 5D shows PMF as a function of interlayer spacing for ce-, acetate- and amide-MoS₂. FIG. 5E shows the density of water as a function of the z-coordinate in an acetate-MoS₂ channel. Here, profiles are shown for interlayer spacings that exhibit clearly resolved water layering.

FIGS. 6A-6C show characterization of ce-MoS₂ at various stages of synthesis. FIG. 6A shows an AFM image of flakes drop cast on a Si wafer with height profile inset. The height profile indicates that these flakes are mono to bilayer. FIG. 6B shows a TEM image of 10 nm thin ce-MoS₂ film, where individual flakes are identifiable. FIG. 6C shows a cross-sectional SEM image of ce-MoS₂ membrane on a mixed cellulose ester substrate.

FIGS. 7A-7C show deconvolved XPS spectra of MoS₂. FIG. 7A shows an XPS spectrum in the Mo3d region for ce-, acetate- and amide-MoS₂. FIG. 7B shows an XPS spectrum in the Mo3p region for ce- and amide-MoS₂; the peak assigned to the N1s orbital is apparent in amide-MoS₂, but no such peak is evident in ce-MoS₂. FIG. 7C shows the C1s region for ce-, acetate- and amide-MoS₂. Functionalized MoS₂ shows clear evidence of a carbonyl peak.

FIGS. 8A-8B show cross-sectional TEM images of ce-MoS₂. FIG. 8A shows a TEM cross-section of 20 nm thick ce-MoS₂ membrane showing clear evidence of laminar structure at the nanometer scale. FIG. 8B shows a TEM cross section of ce-MoS₂ membrane showing the interlayer separation roughly matching that of ce-MoS₂.

FIG. 9 shows XRD of 2 μm acetate-MoS₂ membrane, dried and rewet by soaking in deionized water for 12 hours. This same membrane was, immediately after characterization, freeze dried and characterized by SEM (FIG. 10C). It was noted that the dried interlayer spacing was marginally (0.4 Å) smaller than that measured for thinner dried acetate-MoS₂ membranes; this may originate from the broad underlying XRD spectrum of the polymer substrate, which has a varying relative influence depending on membrane thickness.

FIGS. 10A-10C show MoS₂ void characterization using SEM. FIG. 10A shows a SEM cross-section of 3 μm dried MoS₂ membranes. Images from two membranes are shown: images 1-5 are taken at different points along the same membrane, and image 6 is from a separate sample. FIG. 10B shows a SEM cross section of 3 μm freeze dried MoS₂ membrane, showing images from two samples (images 1˜4 and 5-6). FIG. 10C shows a SEM cross section of 2 μm acetate-MoS₂, all from different portions of the same membrane. It was noted that all images display similar qualitative structures: the variation between images provides the uncertainty in the void fraction profiles depicted by the shaded region in FIG. 3D.

FIG. 11 shows XRD characterizing the microporous structure of amide-MoS₂. No bulk ce-MoS₂ peak is visible. As the membrane dried, the amide-MoS₂ peak shifted to slightly smaller interlayer separations, displaying similar behavior to that of acetate-MoS₂.

FIG. 12 shows thickness-dependent performance for ce- and acetate-MoS₂. The lower flux for the 100 nm ce-MoS₂ membrane dried for 20 min was associated relative to the 200 nm ce-MoS₂ membrane dried for the same period to varying drying rates for the two samples. All trials are an average of at least two measurements.

FIG. 13 shows contact angles are measured with ultrapure water on MoS₂ membranes. Reported values are an average of at least four measurements. Of note is the greater hydrophobicity of amide-MoS₂, resulting from the quenching of ce-MoS₂ surface charge.

FIGS. 14A-14D show MD simulations of water density as a function of the distance away from the channel center for a range of interlayer spacings for: (FIG. 14A) ce-MoS₂, (FIG. 14B) acetate-MoS₂, (FIG. 14C) amide-MoS₂, and (FIG. 14D) neutral-MoS₂. It was noted that for ce-MoS₂, the monolayer of water at the 10 Å interlayer spacing was pulled apart slightly by the surface charge. This resulted in two peaks in the density profile, even though there was only one layer of water. These peaks are much closer together and less resolved than the true bilayer of water visible at the 12 Å interlayer spacing.

FIGS. 15A-15B show MD simulation results for neutral MoS₂, compared with the results for ce-, acetate-, and amide-MoS₂ presented in the main text. FIG. 15A shows PMF as a function of interlayer spacing. The global minimum is at ˜10 Å. FIG. 15B shows the diffusion constant of water as a function of interlayer spacing in a neutral MoS₂ channel. The anomalous enhancement in water diffusion at 11 Å is attributed to a dramatic decrease in water density (FIG. 14D). Unfortunately, this qualitative feature was not present in the more experimentally feasible systems of charged ce-MoS₂ and functionalized MoS₂ probed in this study. Furthermore, the large enhancement occurred near the top of the barrier in the PMF, making it even more experimentally challenging to probe.

FIG. 16 shows a snapshot of an MD simulation used to compute the PMFs in FIG. 5C, showing the full extent of the simulation box in the x- and z-dimensions. The simulation box was about 13×3×7 nm³, with some variation depending on the interlayer spacing. The MoS₂ sheets were about 6 nm long in the x-direction. In this snapshot, the interlayer spacing was about 12 Å.

FIG. 17 shows PMF as a function of interlayer spacing with van der Waals interactions turned off for neutral, ce-, acetate- and amide-MoS₂. Since these van der Waals interactions were attractive at the length-scales of interest here, removing them destabilized the 10 Å minimum relative to the 12.5 Å one. Comparing to FIG. 15A and FIG. 5D, it can be seen that the change in relative stability is about 30 kcal mol⁻¹ for all four types of MoS₂. The form and parameterization of van der Waals interactions can vary dramatically between MoS₂ force fields, calling into question the robustness of the PMF calculations with respect to the choice of force field. This figure demonstrates that even with no van der Waals interactions (an unphysical choice), the conclusions remain qualitatively unchanged. This indicates that the MoS₂—MoS₂ van der Waals interactions are relatively unimportant in controlling the interlayer separation in an aqueous environment, and instead Coulomb and hydration forces dominate.

### DETAILED DESCRIPTION

Molybdenum disulfide membranes for ionic and/or molecular filtration applications are provided. The membranes have high separation performance, including high water flux and high molecule/ion rejection, and do not need to be stored in a hydrated condition in order to enable their reuse.

The membranes are based on stacked MoS₂ sheets having small hydrophilic organic functional groups covalently bound thereto. The functional groups serve to reduce or eliminate mesoporous voids between MoS₂ sheets, to provide a more uniform and optimal interlayer spacing, and to render the membranes reusable after drying.

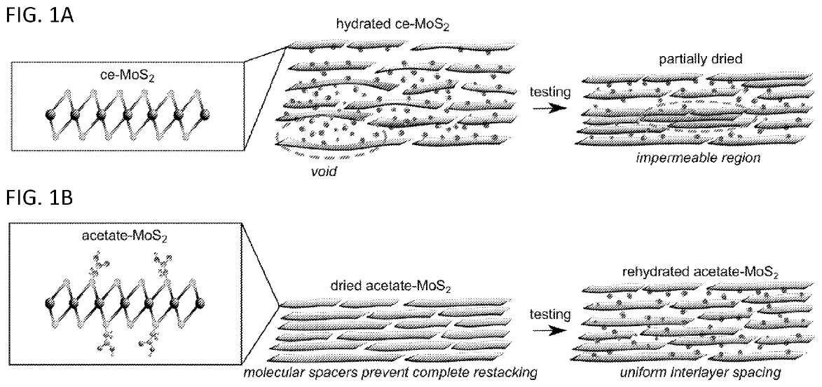

The covalently functionalized MoS₂ sheets can be made from exfoliated MoS₂ (e.g., chemically exfoliated MoS₂), whereby the exfoliated MoS₂ sheets are covalently functionalized and then restacked to form a membrane comprising vertically stacked, horizontally aligned sheets of MoS₂ with covalently bound organic functional groups intercalated between the sheets. A schematic illustration of a membrane is shown in FIG. 1B. As shown in that figure, multiple smaller MoS₂ sheets or “flakes” may be arranged to form a single layer in the stacked structures. Typical lateral flake dimensions are in the range from about 100 nm to about 500 nm. However, flakes with lateral dimensions outside of this range can be used.

Without intending to be bound to any particular theory of the invention, the inventors observe that the organic functional groups can prevent regions of local impermeability from forming in the membranes upon drying, due to irreversible restacking of the MoS₂ sheets into a bulk stacked morphology. This is illustrated in FIGS. 1A-1B. As depicted in FIG. 1A, as an unfunctionalized MoS₂ membrane dries, water molecules diffuse out from the spaces between the MoS₂ flakes, allowing portions of the membrane to irreversibly restack to its bulk state, which is impermeable to water. When the membrane is completely dried, it is possible for all or substantially all of the MoS₂ sheets to become restacked in a water-impermeable bulk configuration. As a result, the drying of the unfunctionalized membrane effectively prevents its reuse. At the same time, the surface tension of the receding water surface can also force mesoporous scale voids within the membrane to close, forming a more uniform and ordered membrane. These two parallel effects (restacking to bulk and void closing) have opposing impacts on filtration performance; mesoscale void closing improves performance, but restacking to a bulk form leads to water impermeability.

In contrast, the organic functional groups used in the membranes described herein allow for the closing of mesoscale pores, while preventing the MoS₂ sheets in the membrane from irreversibly collapsing into the bulk state during drying, where a bulk state can be detected using XRD, as illustrated in the Example. Thus, the present membranes can be dried to remove the mesoscale voids without sacrificing water permeability (FIG. 1B). This eliminates the need to control the drying process precisely, as well as the need to store the membranes in a hydrated state between uses. In some examples of the functionalized membranes, an interlayer spacing between MoS₂ sheets of at least 9 Å is maintained even when the membranes are dry. This includes embodiments in which an interlayer spacing of at least 9.7 Å is achieved. Methods for measuring interlayer spacings are described in the Example.

In addition, the hydrophilic organic functional groups promote the swelling of the membranes in water and may tune the structure of water within the MoS₂ channel to provide an interlayer spacing between the MoS₂ sheets that promotes both high water flux and high ion/molecule rejection when the membranes are in a hydrated state. For example, interlayer spacings between the MoS₂ sheets in neighboring layers in the range from 11 Å to 12 Å can be achieved.

For the purposes of this disclosure, an organic functional group may be considered hydrophilic if a MoS₂ membrane that is functionalized with the organic functional groups has a hydrophilicity that is the same as, or greater than, that of the unfunctionalized MoS₂. Hydrophilicity can be measured via water contact angle measurements, as described in the Example, where a greater hydrophilicity corresponds to a lower water contact angle. By way of illustration, membranes functionalized with hydrophilic organic functional groups may have water contact angles of 65° or lower, including 60° or lower. Organic functional groups that impart a net negative charge at neutral pH (pH=7) to the membranes can be used as hydrophilic functionalities.

Acetic acid and nitrile groups are examples of hydrophilic organic functional groups that can be used to covalently functionalize the MoS₂ membranes.

The degree of membrane functionalization should be sufficient to provide adequate water flux and molecule and/or ion rejection properties for the intended filtration application. By way of illustration, some embodiments of the MoS₂ membranes have a degree of organic (e.g., acetic acid and/or nitrile) functionalization of at least 10%, including embodiments having a degree of functionalization of at least 20%. For example, some of the MoS₂ membranes have a degree of organic (e.g., acetic acid and/or nitrile) functionalization in the range from about 20% to about 40%. However, degrees of functionalization outside of this range can be used. As used herein, the degree of functionalization refers to the ratio of functional groups to molybdenum atoms.

The membranes can be incorporated into filtration devices for the separation and removal of a variety of ions and/or small molecules from liquid samples, particularly aqueous liquid samples. In a filtration device, the sample is flowed through the channels defined between the layers of aligned MoS₂ sheets with little obstruction, while ions and other small molecules having sizes greater than the channel widths are excluded. The filtration devices may further include various components that are common to such devices, such as a housing, a membrane support, an input chamber, an output chamber, and valves and/or pumps to control liquid flow, wherein the membrane is disposed between the input and output chambers. Once the filtration is complete, the excluded ions and/or molecules may be collected and removed from the filtration device.

The removal of salt ions, such as Na⁺ and/or Cl⁻, from salinized water is one application for which the membranes are well-suited. The salinized water may be from a natural body of water (e.g., seawater) or wastewater from an industrial or municipal plant. Other ions that can be filtered using the membranes include, but are not limited to, inorganic anions and/or cations, such as K⁺, Ca⁺, Mg²⁺, and SO₄²⁺ and small organic molecules.

The molybdenum disulfide membranes can be made by forming an aqueous suspension of exfoliated MoS₂ sheets and adding an organohalide compound, such as an acetate halide (e.g., iodoacetic acid) or a nitrile halide (e.g., iodonitrile) to the aqueous suspension, whereby the organohalide compound reacts with the MoS₂ sheets to form MoS₂ sheets that are covalently functionalized with organic groups from the organohalide compound. The suspension can then be filtered on a porous polymer substrate, such as cellulose ether, to form a supported membrane comprising stacked sheets of the covalently functionalized MoS₂ sheets. The membrane is then dried and delaminated from the porous polymer substrate to form a free-standing membrane. The MoS₂ particles may be exfoliated using, for example, lithium intercalation. The suspension can be filtering using, for example, vacuum filtration. The membrane can be delaminated from the porous polymer substrate by, for example, submerging the membrane and the substrate in water.

### Example

This Example describes the results of an array of tests that probed the structure of MoS₂ membranes on a wide range of length scales. From powder x-ray diffraction (XRD) and scanning electron microscopy (SEM) studies, paired with reverse osmosis (RO) tests, it was found that the physical structure of MoS₂ membranes evolved with the hydration level (determined by the membrane drying time) at both ˜1 nm (microporous) and ˜100 nm (mesoporous) length scales.

This Example describes the water structure that determines the microporous scale membrane morphology, as well as the diffusion of water molecules, at a range of interlayer spacings and surface chemistries using molecular dynamics (MD) simulations. The MD simulations predicted that a bilayer of water occupies the membrane channels at the interlayer spacing that were measured experimentally for ce-MoS₂ and acetate-MoS₂, but that a smaller interlayer spacing with only a single layer of water was more stable for amide-MoS₂. It was also found that water diffusion in the membrane was tuned by surface functionalization, but that this had a modest effect on overall water flux relative to the changes in the membrane structure on the micro and mesoporous scales that come with functionalization.

### Results

### Synthesis and Characterization of MoS₂ Based Membranes

An aqueous suspension of ce-MoS₂ flakes were synthesized following the standard lithium-intercalation and exfoliation procedure outlined in the Methods section of this disclosure. (Eda, G. et al., Nano Lett 11, 5111-5116 (2011); Joensen, P., et al., Materials Research Bulletin 21, 457-461 (1986); and Zheng, J. et al., Nat Commun 5, 2995 (2014).) The detailed physical characteristics of individual flakes are provided in Section 1 of Supplementary Information. The flakes were generally 100-500 nm in lateral size and only a few nm in total thickness. Membranes were assembled via vacuum filtration on a porous polymer substrate (mixed cellulose ester, 25 nm average pore diameter).

ce-MoS₂ sheets were covalently functionalized with two small organic molecules: iodoacetic acid and iodoacetamide. The procedure provided in recent studies and outlined in the Methods section of this disclosure was followed to graft these organic molecules on MoS₂ flakes. (Paredes, J. I. et al., ACS Appl. Mater. Interfaces 8, 27974-27986 (2016); Voiry, D. et al. Nature Chem 7, 45-49 (2015).) The mechanisms underlying the covalent functionalization are outlined in Section 2 of Supplementary Information. Importantly, the net negative surface charge of ce-MoS₂ (˜0.25 electrons per Mo atom) was neutralized during functionalization. Acetic acid, however, deprotonated in neutral pH and induced a net negative charge on the sheet of equal magnitude to that of ce-MoS₂; the sheets remained neutral for amide-MoS₂.

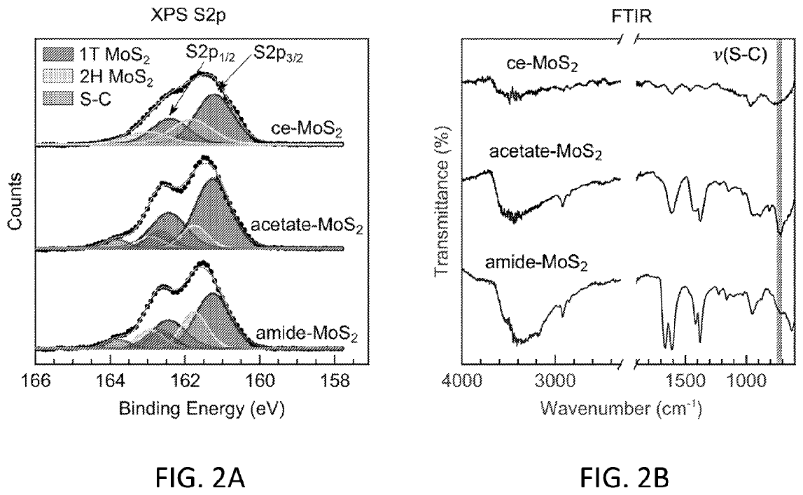

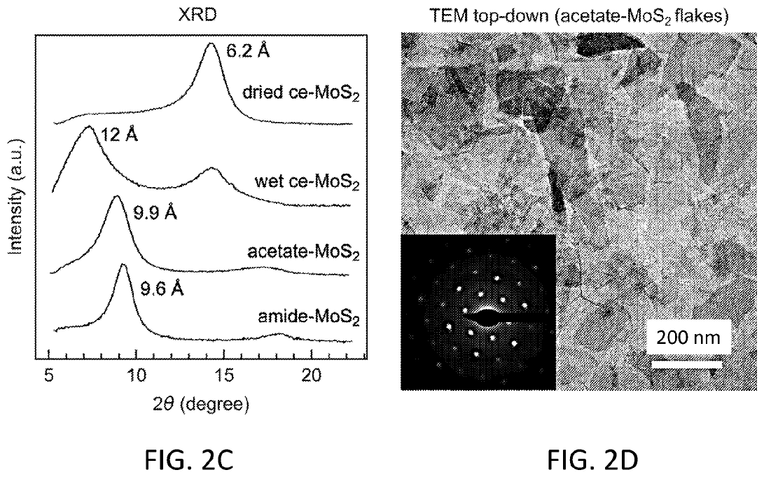

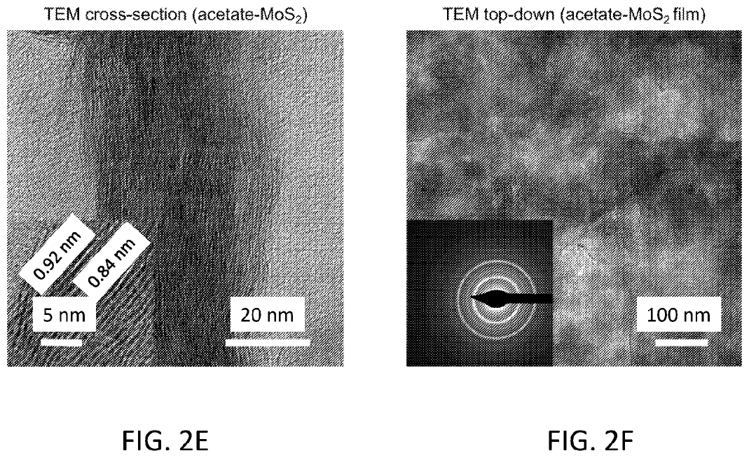

The fraction of organic fragments decorating the MoS₂ surface was determined via X-ray photoelectron spectroscopy (XPS) of samples drop cast on Si wafers. The degree of functionalization could be obtained by deconvolving the S2p region (FIG. 2A) into 2H and 1T phases, with contributions from S2p orbitals and, for functionalized MoS₂, S—C bonds. The degree of functionalization (functional group per Mo atom) was also derived from the C1s region, as well as the N1s region for acetamide-MoS₂. Using all three methods, the degree of functionalization was calculated to be 20-26% for acetate-MoS₂ and 22-26% for amide-MoS₂ (Section 2 of Supplementary Information). More evidence of the covalent nature of the S—C bond on functionalized MoS₂ was provided by attenuated total reflectance Fourier-transform infrared spectroscopy (FTIR) spectra displayed in FIG. 2B; S—C stretching peaks at ˜720 cm⁻¹ and ˜710 cm⁻¹ are visible for acetate-MoS₂ and amide-MoS₂, respectively.

The structure of MoS₂ membranes on the microporous scale was determined via a combination of XRD and TEM. The interlayer spacing, the parameter most directly affecting ion separation performance, was determined via XRD to be 6.2 Å (bulk-like) for dried ce-MoS₂; as shown in FIG. 2C, this value grew to 9.9 Å and 9.6 Å for dried acetate- and amide-MoS₂, respectively. The interlayer spacings of acetate-MoS₂ and amide-MoS₂ fell between dried and hydrated ce-MoS₂ (12 Å), indicating that the shift originated from the presence of the functional groups as opposed to trapped water. Finally, no bulk-like peak was evident in functionalized MoS₂ XRD spectra, indicating complete and uniform decoration of MoS₂ flakes.

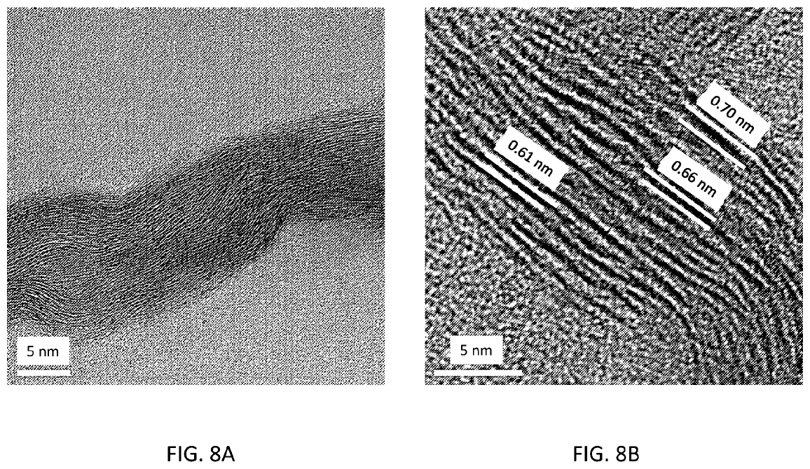

Flakes of acetate-MoS₂, characterized by TEM in FIG. 2D, displayed similar morphology to and retained the hexagonal in-plane crystal structure of ce-MoS₂ (diffraction pattern shown in inset). As a result of this preservation, acetate-MoS₂ membranes had a similar layered structure to that of ce-MoS₂ membranes, only with an expanded interlayer spacing as shown in the TEM cross-section images in FIG. 2E and FIGS. 8A-8B (see Methods for characterization details). When made into membranes, the flakes stacked with their basal planes aligned but in random rotational orientations, leading to the continuous, circular diffraction pattern shown in FIG. 2F.

### Hydration-Dependent Structure of MoS₂ Based Membranes

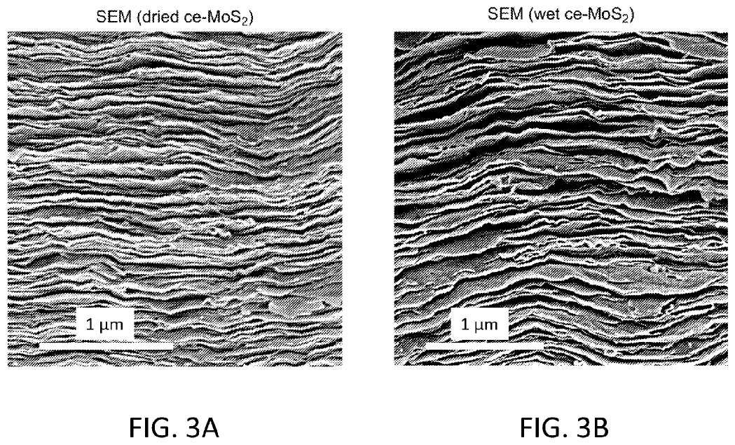

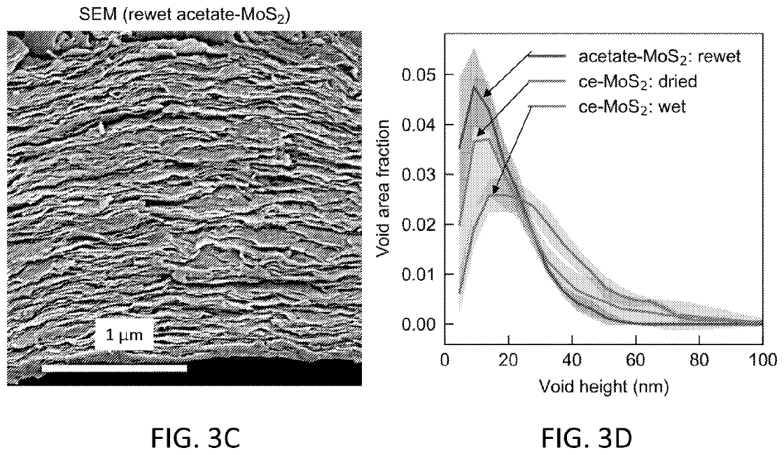

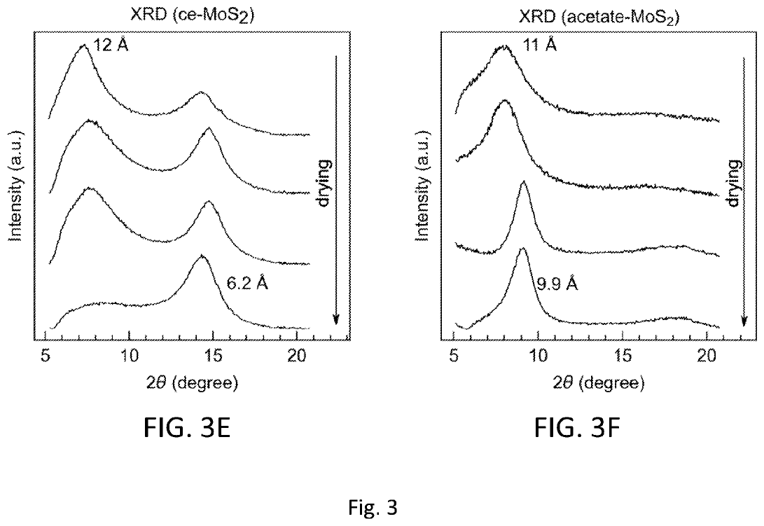

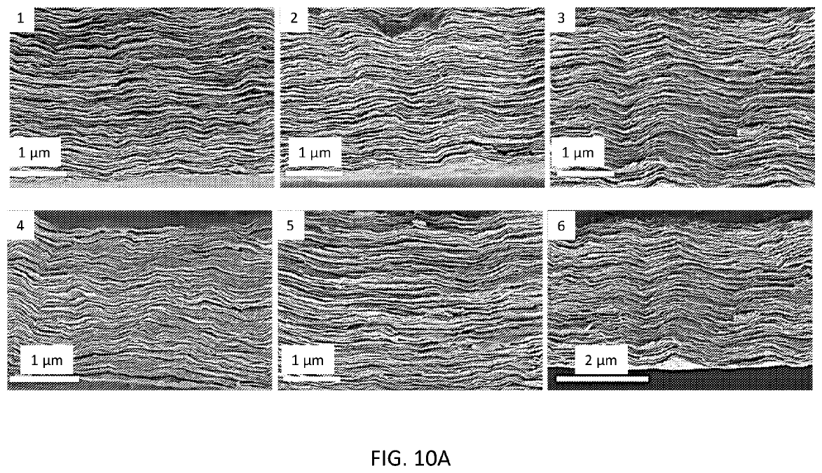

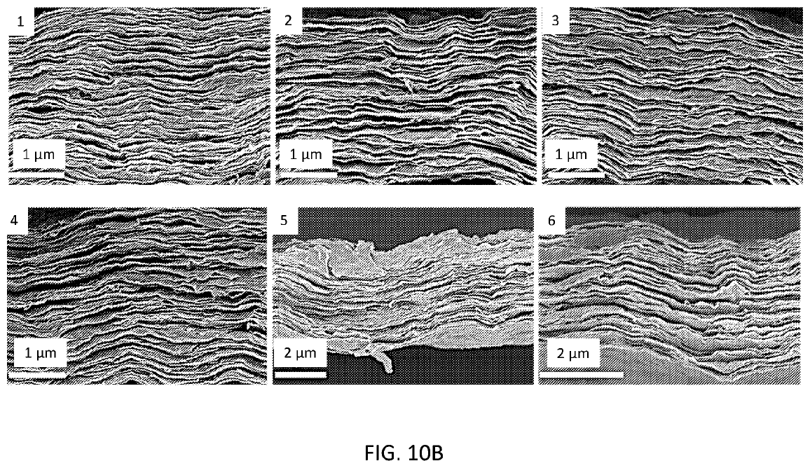

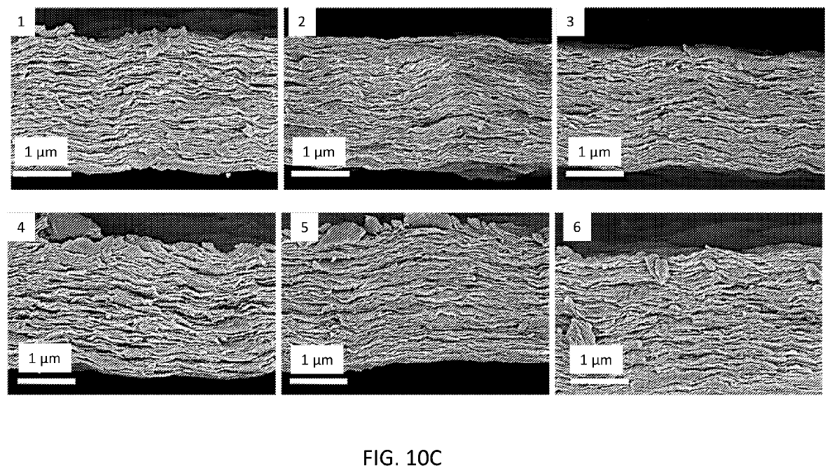

Direct visualization of the hydrated MoS₂ membrane structure was accomplished using a standard freeze drying procedure, outlined in Section 4 of Supplementary Information. This procedure allows direct visual comparison between dried ce-MoS₂ (FIG. 3A), hydrated ce-MoS₂ (FIG. 3B), and rehydrated acetate-MoS₂ (FIG. 3C) on the mesoporous scale. Rehydrated acetate-MoS₂ was dried, then soaked in water overnight to facilitate rehydration (see Section 4 of Supplementary Information for details). The membrane structure evident in SEM images was similar for rehydrated acetate-MoS₂ and dried ce-MoS₂ but differed notably for hydrated ce-MoS₂. In rehydrated acetate-MoS₂ and dried ce-MoS₂, the layers were highly regular and well aligned; in hydrated ce-MoS₂, the layers were separated by mesoporous scale voids. The qualitative structure of these membranes was consistent throughout a given membrane and between membranes (FIGS. 10A-10C). A quantitative depiction of the void height distribution (see Section 5 of Supplementary Information for the procedure) is shown in FIG. 3D; as expected, hydrated ce-MoS₂ displayed a broader peak at larger values (˜20 nm) compared to dried ce-MoS₂ and acetate-MoS₂ (˜10 nm). From this result, it is concluded that with partial drying or surface functionalization and rehydration, the size of mesoporous scale voids can be greatly reduced.

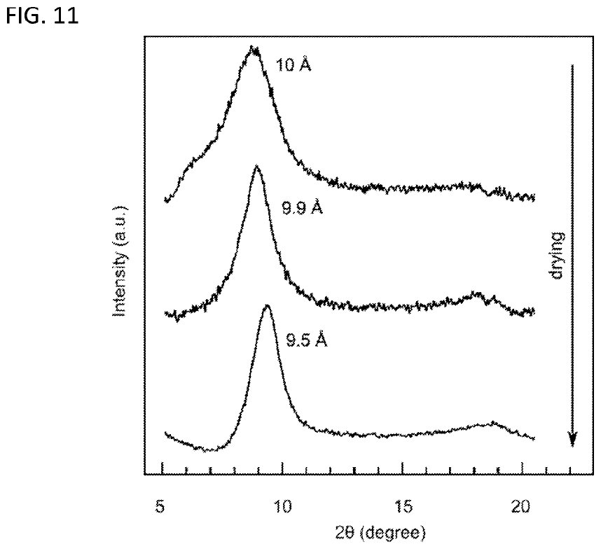

The evolving mesoporous scale morphology is accompanied by evolving structure on the microporous scale. As shown in the XRD spectra in FIG. 3E, in wet ce-MoS₂, the bulk (6.2 Å) and hydrated (12 Å) interlayer spacings coexist. As the membrane dried, the XRD peak corresponding to 12 Å interlayer spacing decreased in intensity, while the peak at 6.2 Å increased. This evolution indicates irreversible stacking to bulk MoS₂. In contrast, no bulk peak (6.2 Å) was ever present in acetate-MoS₂ (FIG. 3F); the singular channel width simply shifted to smaller values as water left the membrane (from 11 Å to 9.9 Å); it was found that water can re-enter the channels held open by the acetate functional groups on the MoS₂ surface. Amide-MoS₂ demonstrated similar behavior to acetate-MoS₂ with XRD peak shifts from 9.9 Å to 9.6 Å without evidence of a bulk peak at 6.2 Å during drying (FIG. 11).

### Separation Performance of MoS₂ Based Membranes

The evolving structure of ce-MoS₂ membranes dramatically affects separation performance, as indicated by the dependence of water flux and ion rejection on membrane drying time. To detail this association, membranes were dried for a defined period in room temperature conditions (humidity 20-30%) after fabrication, then loaded in a stirred, pressure-assisted dead-end filtration cell for tests. All samples were tested in brackish water conditions with 17 mM (˜2500 ppm) Na₂SO₄ under pressures of 150 psi (10.3 bar). The performance metrics were measured until the ion rejection stabilized.

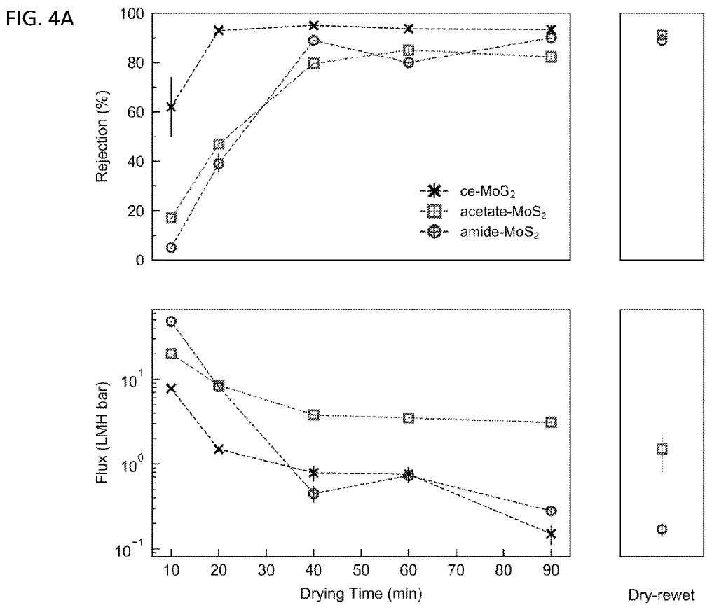

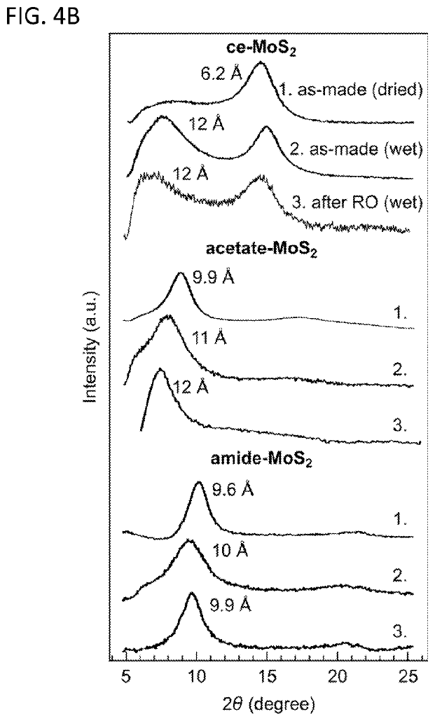

The flux through ce-MoS₂ membranes decreased by two orders of magnitude as a function of drying time, a result of the closing of voids and restacking to bulk (FIG. 4A). The ion rejection of ce-MoS₂ membranes increased only within the initial drying period but subsequently remained constant. The initial increase in rejection was associated with the closure of percolating voids. Once these voids were closed, no further increase in ion rejection was expected, despite lower water flux values; restacking to bulk entirely sealed off portions of the membrane instead of forming smaller water channels. By tuning the drying time (to the minute), ce-MoS₂ membranes can display performance as high as 95(1)% rejection of Na₂SO₄ with 0.8(2) LMH bar water flux. Even though ce-MoS₂ shows great potential for ion separations, the transient membrane structure makes the membrane hard to preserve for practical applications.

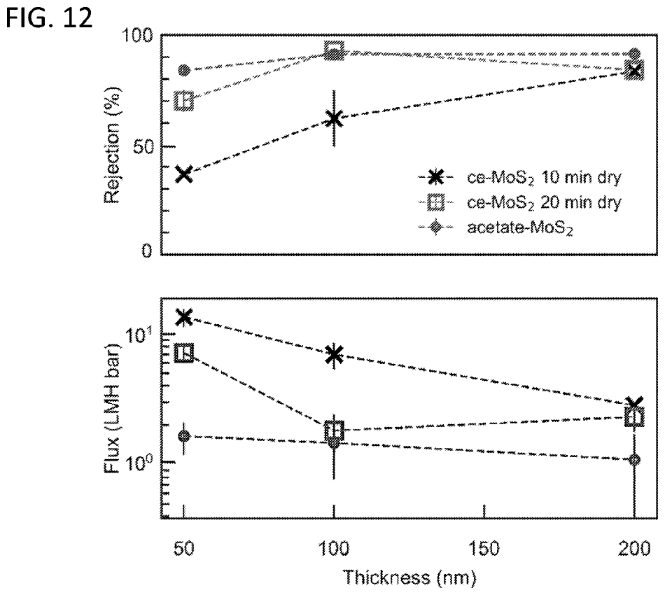

The drying-dependent performance of acetate-MoS₂ differed qualitatively from that of ce-MoS₂. The ion rejection plateaued more slowly for acetate-MoS₂ membranes (FIG. 4A). Furthermore, when the membrane was dried completely by heating at 60° C. for four hours, water flowed at 1.5(7) LMH bar while ion rejection reached 91(1)% (ce-MoS₂ membranes dried under the same conditions were impermeable). This result demonstrates that functionalizing MoS₂ with acetate ions is a reliable method to achieve high rejection of divalent ions, only transiently attainable via partial drying of ce-MoS₂. The amide-MoS₂ membranes behaved similarly to the acetate-MoS₂ membranes, except that at longer drying times the amide-MoS₂ membranes exhibited smaller flux. They did remain permeable after complete drying, however, unlike the ce-MoS₂ membranes: dried amide-MoS₂ membranes exhibited 89.0(1)% rejection with a flux of 0.7(2) LMH bar. The flux and rejection for both ce- and acetate-MoS₂ varied linearly with membrane thickness (FIG. 12).

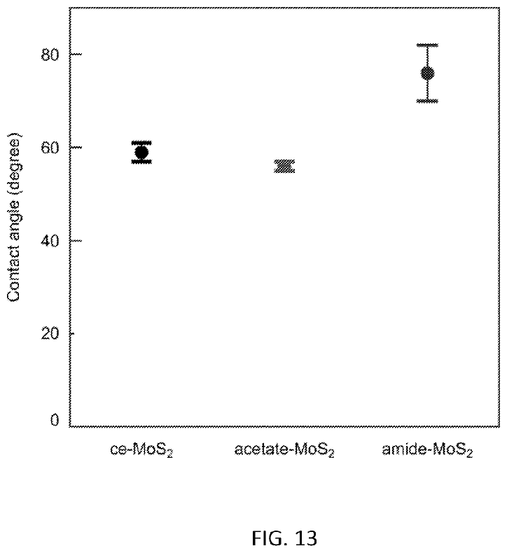

The dependence of water flux on MoS₂ surface treatment was a result of differing water diffusion constants within membrane channels and varying membrane porosities. Diffusion constants were calculated via MD simulations discussed in the subsequent section; porosity was partly determined by the widths of the MoS₂ channel, which can be measured by XRD. As depicted in FIG. 4B, ce-MoS₂ partially restacked to bulk, decreasing the effective porosity of the membrane, whereas the acetate- and amide-MoS₂ channels remained uniformly open. The different behaviors demonstrated by amide-MoS₂ and acetate-MoS₂ were likely a result of their differing hydrophilicities (FIG. 13). During membrane testing, the hydrophilic acetate-MoS₂ membranes swelled as water was forced through the channels defined by neighboring flakes. The interlayer spacing increased from 9.9 Å to 12 Å, based on XRD measurements performed immediately after tests (FIG. 4B), to match that of hydrated ce-MoS₂. The interlayer spacing of the more hydrophobic amide-MoS₂, on the other hand, remained relatively constant (increasing only 0.3 Å, from 9.6 Å to 9.9 Å, an order of magnitude less than that of acetate-MoS₂). The XRD results revealed that the microporous scale features depend largely on the hydration level for ce-MoS₂, but through surface functionalization and rehydration, uniform microporous scale features can be achieved. In the following sections, MD simulations were employed to provide a quantitative description of the microporous structure of ce- and functionalized MoS₂ that rationalized with greater detail each sample's swelling behavior.

### MD Simulations: Water Dynamics in MoS₂ Channels

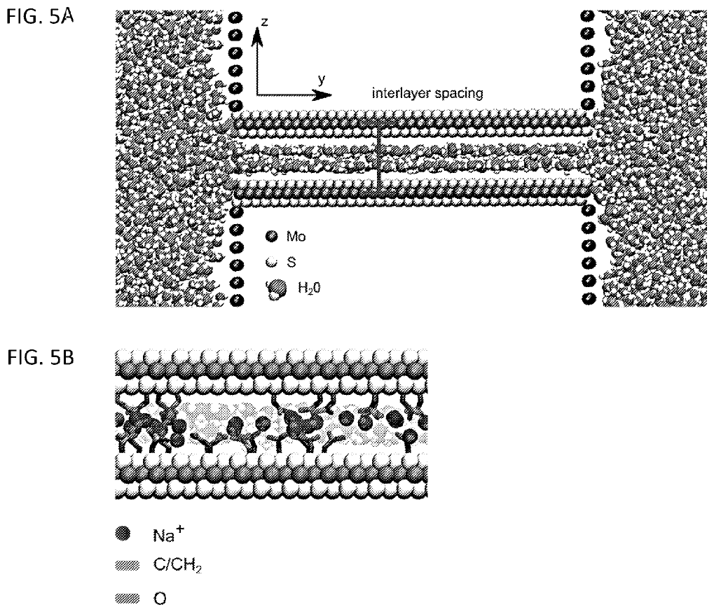

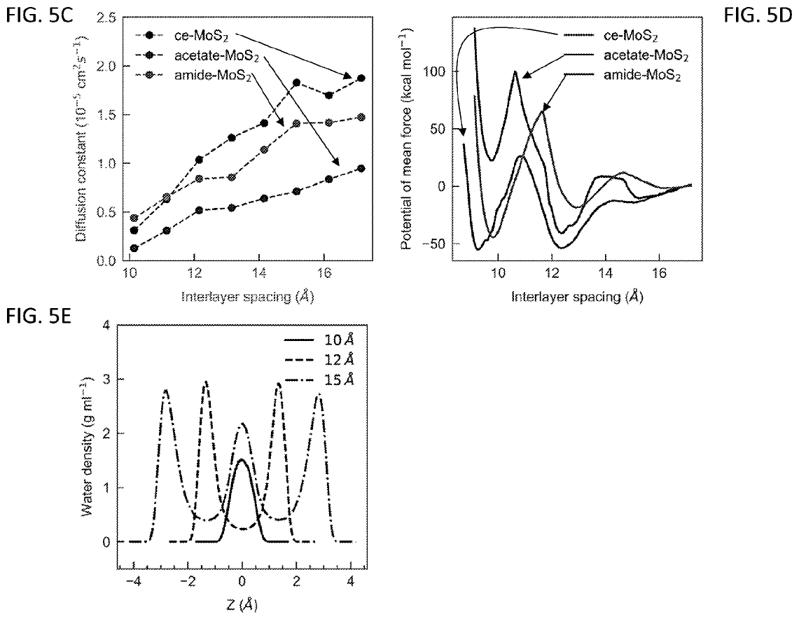

To elucidate the factors contributing to water diffusion in ce- and functionalized MoS₂, MD simulations were conducted on single channels formed by parallel MoS₂ sheets. By characterizing the water structure and dynamics at a sequence of interlayer spacings for ce-, acetate- and amide-MoS₂, the entire parameter space attainable was covered in the experiments. The setup shown in FIG. 5A was employed, wherein two MoS₂ layers were separated by the distance defined by the interlayer (center-to-center Mo—Mo) spacing. To probe the effects of surface modification, the MoS₂ sheets were decorated with functional groups at a similar density to that measured experimentally (FIG. 5B).

To compare water flux between samples, the diffusion constant (derived from the mean squared displacement of water molecules in the MoS₂ channel) was computed for interlayer spacings from 10 to 17 Å. It was found that for a 12 Å interlayer spacing, the diffusion constant varied with surface chemistry as ce-MoS₂>amide-MoS₂>acetate-MoS₂ (FIG. 5C). The lower diffusion constants for acetate-MoS₂ and amide-MoS₂ were partially attributed to steric obstruction arising from the functional groups extruding from the MoS₂ surface. Provided consistent interlayer spacing and mesoscale morphology for all membrane surface chemistries tested here, the MD simulations indicate that ce-MoS₂ should exhibit the fastest water flux. Experimentally, however, ce- and acetate-MoS₂ had equivalent hydrated interlayer spacings (12 Å) but acetate-MoS₂ demonstrated the highest water flux. This result suggests that the restacking to bulk behavior effectively reduced the porosity of the membrane (or increased the tortuosity), leading to dramatic reductions in flux that overcame the marginally larger diffusion constant for ce-MoS₂ relative to functionalized MoS₂. The reduced flux of amide-MoS₂ relative to acetate-MoS₂ likely derived from its smaller interlayer spacing in the hydrated state. An analytical relationship between these morphological factors and the total water flux through the MoS₂ membranes tested here is provided in Section 9 of Supplementary Information.

### MD Simulations: Water Structure and Interlayer Spacing

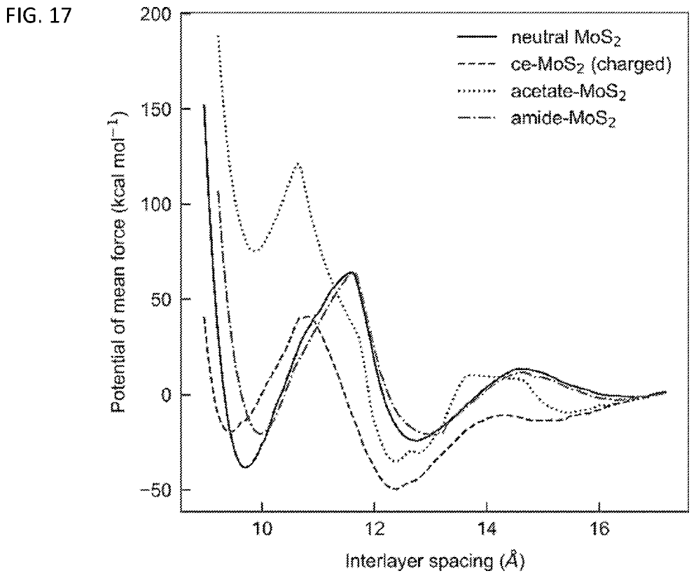

The equilibrium spacing between MoS₂ sheets in an aqueous medium governed the ion rejection and water flux through the membranes assembled from those sheets. The equilibrium spacing was determined by the complex interplay of electrostatic and Van der Waals interactions, in addition to hydration forces arising from the confinement of water in the MoS₂ channel. To quantify the sum of these interactions, umbrella sampling was used to calculate the potential of mean force (PMF) as a function of interlayer spacing (FIG. 5D). This approach captured the effects of water structure on the interlayer spacing at the sub-nm scale, the details of which were not included in models such as extended DLVO theory. One might expect the model-system approach, which was parameterized to capture water-water and water-MoS₂ interactions but not MoS₂—MoS₂ interactions, to be inadequate to understand the PMF between MoS₂ sheets. While the method may break down at small interlayer spacings where MoS₂—MoS₂ interactions dominate, at the spacings of interest here, the MoS₂ interactions were largely mediated by water molecules, and hydration forces dominated (see FIG. 17).

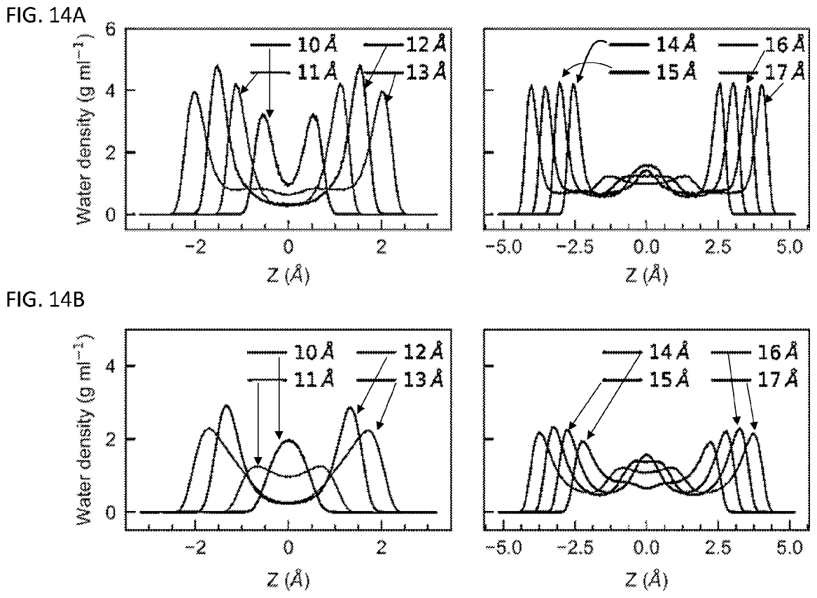

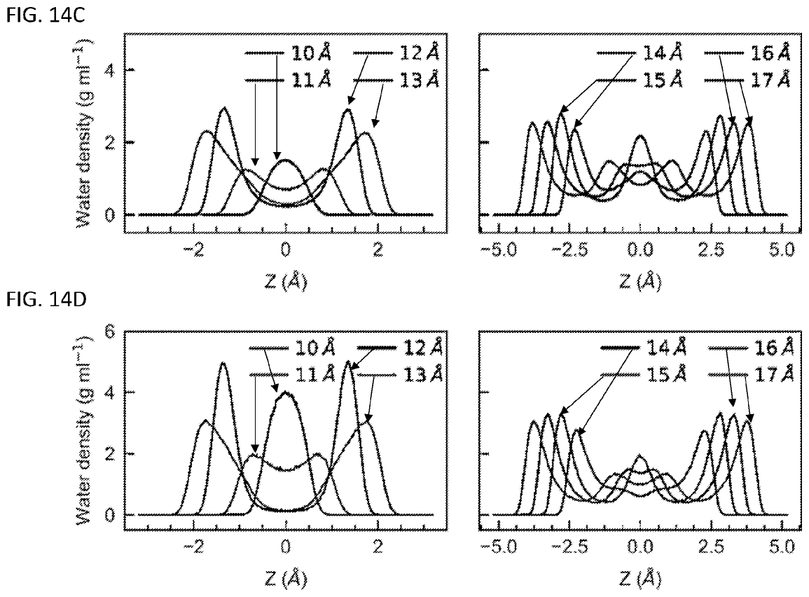

The PMF profiles depicted in FIG. 5D display clear minima at around 9-10 Å and 12-13 Å, but the relative depths of these two minima vary dramatically with surface functionalization. As detailed in Section 13 of Supplementary Information, these minima and their relative depths explain the stability and value of the interlayer spacing of ce- and functionalized MoS₂ membranes in aqueous media. The structure of the PMFs in FIG. 5D can be interpreted in terms of interactions in the system at the molecular level. The overall oscillatory structure is well understood and is a result of the discrete nature of the water layers confined within the channel. To illustrate this, the water density profile was computed along the membrane normal at fixed interlayer spacings between 10 and 17 Å (FIGS. 14A-14D). The minima in the PMF profiles at around 10 Å, 12.5 Å and 15 Å correspond to one, two, and three layers of water inside the channel, respectively; this is shown for acetate-MoS₂ in FIG. 5E.

Given that hydrated ce- and acetate-MoS₂ membranes have experimental interlayer spacings of 12 Å, the density profiles in FIG. 5E and FIGS. 14A-14D indicate that each MoS₂ sheet adsorbs a single layer of water approximately 2 Å thick. It was concluded that a bilayer of water occupied each channel. These results also indicate that the steric effects of functional groups decorating the MoS₂ surface were secondary to that of the structure of water within the MoS₂ channel: within the current experimental setup, the interlayer spacing can only take on discrete values corresponding to an integer number of water layers.

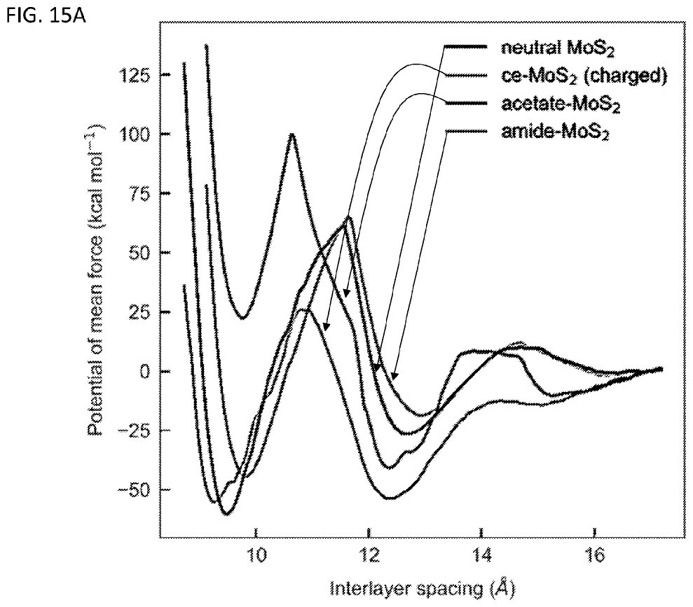

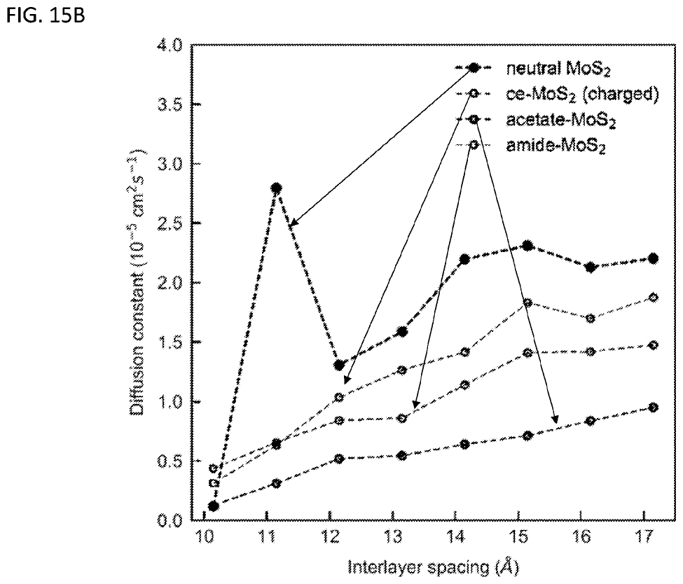

FIGS. 15A-15B show MD simulation results for neutral MoS₂, compared with the results for ce-, acetate-, and amide-MoS₂ presented in the main text. FIG. 15A shows PMF as a function of interlayer spacing. The global minimum is at ˜10 Å. FIG. 15B shows the diffusion constant of water as a function of interlayer spacing in a neutral MoS₂ channel. The anomalous enhancement in water diffusion at 11 Å is attributed to a dramatic decrease in water density (FIG. 14D). Unfortunately, this qualitative feature was not present in the more experimentally feasible systems of charged ce-MoS₂ and functionalized MoS₂ probed in this study. Furthermore, the large enhancement occurred near the top of the barrier in the PMF, making it even more experimentally challenging to probe.

### DISCUSSION

It was shown that MoS₂ membranes demonstrate a range of separation performances that depend on the degree of hydration: at short drying times, ce-MoS₂ membranes showed very low rejection but high water permeance; at intermediate drying times, ce-MoS₂ membranes demonstrated high rejection with a moderate water flux; when completely dried they were impermeable. Membrane functionalization is a route towards consistently achieving high salt rejection and water flux, as was demonstrated with acetate functionalized MoS₂ membranes. The more hydrophobic acetamide functionalized MoS₂ membranes demonstrated lower separation performance, perhaps a result of the absence of surface charge. MD simulations revealed the structure of water within the membrane that forms the basis for its hydration dependent structure. In addition, the trends derived from these MD simulations corroborate the dominance of the rehydration behavior of MoS₂ membranes in separation tests and emphasize the importance of water structure on both the microporous and mesoporous scales. This Example provides structural and chemical information of MoS₂ membranes, providing insight into their behavior as separation membranes or when employed in nanofluidic platforms or even as electrode materials.

### Supplementary Information

### XPS Analysis of MoS₂ Samples

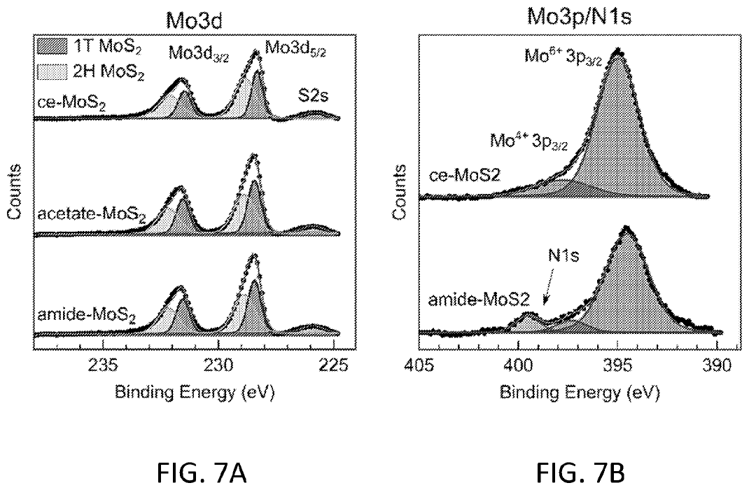

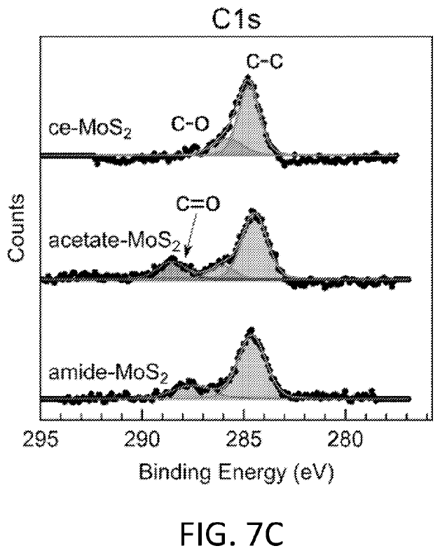

The degree of MoS₂ functionalization was computed by deconvolving XPS spectra with a sum of Gaussian/Lorentzian lineshapes in the S2p, N1s, and C1s regions. First, however, the Mo3d region was analyzed to determine the approximate fraction of 2H and 1T phases (FIG. 7A). (Eda, G. et al. Nano Lett. 11, 5111-5116 (2011).) It was found that the Mo3d spectra for ce-, acetate- and amide-MoS₂ are qualitatively similar, indicating that the Mo atoms were unaffected by covalent modification and the functional groups were localized on the S atoms.

The S2p regions were deconvolved in a similar fashion to that of the Mo3d region (FIG. 2A), where an analogous mixture of 1T and 2H phase MoS₂ was evident. The S2p spectra of functionalized MoS₂ were qualitatively equivalent to each other but differed noticeably from that of ce-MoS₂. Clear S—C components were evident at higher energies. (Voiry, D. et al., Nature Chem 7, 45-49 (2015).) Fitting parameters are provided in Supplementary Table 1. Deconvolution of the N1s spectra (FIG. 7B) corroborates the results derived from the S2p region. (Ries, L. et al., Nat. Mater. 18, 1112-1117 (2019).)

Finally, results were confirmed by analyzing the C1s region (FIG. 7C). The ratio of the carbonyl peak intensity was calculated to that of the adventitious carbon (hydrocarbon contamination), then the total carbon intensity was compared to the Mo intensity. For acetate-MoS₂, the degree of functionalization (per Mo atom) was computed to be 26% and 20% using the S2p and C1s regions, respectively. For amide-MoS₂, the degree of functionalization was calculated to be 26%, 22% and 26% for the S2p, C1s and N1s regions, respectively.

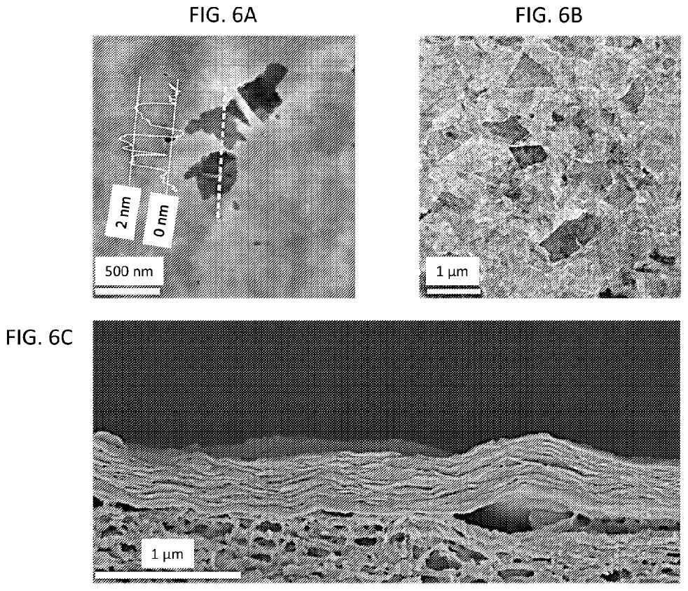

FIGS. 6A-6C show characterization of ce-MoS₂ at various stages of synthesis. FIG. 6A shows an AFM image of flakes drop cast on a Si wafer with height profile inset. The height profile indicates that these flakes are mono to bilayer. FIG. 6B shows a TEM image of 10 nm thin ce-MoS₂ film, where individual flakes are identifiable. FIG. 6C shows a cross-sectional SEM image of ce-MoS₂ membrane on a mixed cellulose ester substrate.

SUPPLEMENTARY TABLE 1
XPS fitting results: parameters for deconvolution of spectra
in FIG. 2A and FIGS. 7A-7C. Atomic percentages that are highlighted
in bold for a given spectrum are summed to provide the degree
of functionalization. Peak positions and widths are provided
to increase reproducibility of these data.

| | | | |
|---|---|---|---|
| | Peak Position | FWHM | |
| Component | (eV) | (eV) | Atomic % |

Ce—MoS₂
Mo 3d

| | | | |
|---|---|---|---|
| 1T Mo3d_{5/2} | 228.32 | 0.57 | 23.5 |
| 1T Mo3d_{3/2} | 231.47 | 0.66 | 15.7 |
| 2H Mo3d_{5/2} | 228.85 | 1.05 | 36.6 |
| 2H Mo3d_{3/2} | 232.11 | 1.22 | 24.1 |

S 2p

| | | | |
|---|---|---|---|
| 1T S2p_{1/2} | 161.22 | 1.18 | 42.5 |
| 1T S2p_{3/2} | 162.40 | 1.18 | 21.7 |
| 2H S2p_{1/2} | 161.82 | 1.33 | 23.7 |
| 2H S2p_{3/2} | 163.00 | 1.33 | 12.1 |

Acetate-MoS₂
Mo 3d

| | | | |
|---|---|---|---|
| 1T Mo3d_{5/2} | 228.41 | 0.71 | 30.1 |
| 1T Mo3d_{3/2} | 231.51 | 0.71 | 19.8 |
| 2H Mo3d_{5/2} | 228.84 | 1.09 | 30.1 |
| 2H Mo3d_{3/2} | 232.18 | 1.09 | 20.0 |

S 2p

| | | | |
|---|---|---|---|
| 1T S2p_{1/2} | 161.26 | 1.11 | 46.3 |
| 1T S2p_{3/2} | 162.44 | 1.11 | 23.6 |
| 2H S2p_{1/2} | 161.75 | 0.82 | 11.4 |
| 2H S2p_{3/2} | 162.93 | 0.82 | 5.8 |
| S—C | 162.67 | 0.8 | 8.6 |
| S—C | 163.85 | 0.8 | 4.3 |

Amide-MoS₂
Mo 3d

| | | | |
|---|---|---|---|
| 1T Mo3d_{5/2} | 228.44 | 0.67 | 27.3 |
| 1T Mo3d_{3/2} | 231.54 | 0.67 | 18.0 |
| 2H Mo3d_{5/2} | 228.88 | 1.11 | 32.9 |
| 2H Mo3d_{3/2} | 232.17 | 1.11 | 21.7 |

S 2p

| | | | |
|---|---|---|---|
| 1T S2p_{1/2} | 161.26 | 1.08 | 38.2 |
| 1T S2p_{3/2} | 162.44 | 1.08 | 19.5 |
| 2H S2p_{1/2} | 161.75 | 0.83 | 19.3 |
| 2H S2p_{3/2} | 162.93 | 0.83 | 9.9 |
| S—C | 162.63 | 0.77 | 8.8 |
| S—C | 163.81 | 0.77 | 4.4 |

N 1s

| | | | |
|---|---|---|---|
| Mo⁶⁺ 3p_{3/2} | 394.54 | 2.61 | 72.7 |
| Mo⁴⁺ 3p_{3/2} | 397.33 | 1.81 | 6.2 |
| N1s | 399.51 | 1.44 | 21.0 |

FIGS. 8A-8B show cross-sectional TEM images of ce-MoS₂. FIG. 8A shows a TEM cross-section of 20 nm thick ce-MoS₂ membrane showing clear evidence of laminar structure at the nanometer scale. FIG. 8B shows a TEM cross section of ce-MoS₂ membrane showing the interlayer separation roughly matching that of ce-MoS₂.

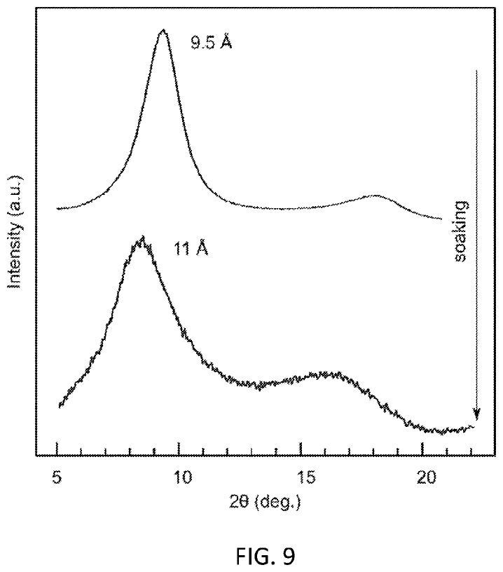

FIG. 9 shows XRD of 2 μm acetate-MoS₂ membrane, dried and rewet by soaking in deionized water for 12 hours. This same membrane was, immediately after characterization, freeze dried and characterized by SEM (FIG. 10C). It was noted that the dried interlayer spacing was marginally (0.4 Å) smaller than that measured for thinner dried acetate-MoS₂ membranes; this may originate from the broad underlying XRD spectrum of the polymer substrate, which has a varying relative influence depending on membrane thickness.

### Relationship Between Flux and Diffusion in MoS₂ Membranes

The experimental measurement of water flow through the membrane is water flux, defined by the flow rate per unit area of membrane. The simplest model of a membrane is an array of straight, unconnected pores extending through the entirety of its bulk. Using this model as a starting point, the flux J through the membrane is determined by the flux through each pore Jₚ times the porosity of the membrane:

$$J = \frac{{N}_{p} {A}_{p}}{{A}_{m}} {J}_{p} \qquad ( 1 )$$

where Nₚ is the number of pores in the membrane, Aₚ is the area of each pore, Aₘ is the area of the full membrane and the factor

$$\frac{{N}_{p} {A}_{p}}{{A}_{m}}$$

is the membrane porosity. The geometry of a MoS₂ membrane is more complicated than the simple picture described above, however. To build a model, a single MoS₂ flake was considered at the surface of a membrane; here, the area available for water permeation was proportional to the space between the flake and the membrane times the circumference of the flake. This area was taken to represent a pore in this system, so

Aₚ˜(d−d_{MoS}_{₂})w (2)

where d is the interlayer spacing, d_{MoS}_{₂}˜6 Å is the thickness of the excluded volume of a single layer of MoS₂, and w is the linear dimension of an average flake (e.g. the flake diameter or side length, depending on the flake geometry). The constant of proportionality is clearly a complicated function of the surrounding flakes and underlying flakes, so this complexity was neglected in favor of a simple model. In this simple model, Nₚ is related to the number of flakes that can fit on the surface of the membrane:

$${N}_{p} ∼ \frac{{A}_{m}}{{w}^{2}} \qquad ( 3 )$$

Putting Supplementary Eqs. 1-3 together gave the following result:

$$J ∼ ( \frac{d - {d}_{M o {S}_{2}}}{w} ) {J}_{p} \qquad ( 4 )$$

The flux through a single pore Jₚ has contributions from the entrance and exit of the pore, as well as the transport through the length of the pore. In the limit where entrance and exit rates are fast relative to intra-pore transport, the flux is related solely to the pressure drop and diffusion constant. This can be seen using Fick's law and the Van't Hoff equation. Fick's law states that the one-dimensional osmotic flux (in this specific case Jₚ) due to a concentration gradient V̅C is,

Jₚ=−DV̅C (5)

where D is the diffusion constant and C is a number concentration. The inventors were interested in flow driven by pressure rather than an osmotic gradient. The osmotic pressure drop generated by a concentration difference is given by the Van't Hoff equation in the low concentration limit

ΔP=k_{B}TΔC (6)

where k_{B} is Boltzmann's constant, T is the temperature and P is the applied pressure. The concentration difference ΔC is measured between two reservoirs on opposite sides of the membrane. The average concentration gradient is given by

$$∇ C = \frac{Δ C}{L} \qquad ( 7 )$$

where L is the distance between the two reservoirs or the thickness of the membrane. Combining Supplementary Eqs. 5-7,

$${J}_{p} = - \frac{D Δ P}{{k}_{B} TL} . \qquad ( 8 )$$

Plugging Supplementary Eq. 8 into Supplementary Eq. 4 gave the following relationship between the experimentally measured flux and the diffusion constant computed through MD simulations:

$$J ∼ ( \frac{d - {d}_{M o {S}_{2}}}{wL} ) ( \frac{D Δ P}{{k}_{B} T} ) . \qquad ( 9 )$$

In a real membrane, the pores are interconnected in complicated ways. Two assumptions can remove this difficulty, however. First, it was assumed that the porosity of each layer is the same; second, it was assumed that the connections between layers permit fast transport, just like the entrances and exits of the channels. Finally, the distance a water molecule must traverse between two reservoirs is much further than the thickness of the membrane, due to the tortuosity of the path. This can be accounted for by simply replacing L with an effective length L_{eff}.

### MD Simulations: Diffusion Constants and Density Profiles

The 1T MoS₂ lattice structure was taken from Py and Haering. (Py, M. A. et al., Can: J. Phys. 61, 76-84 (1983).) Exclusively 1T MoS₂ were used in the simulations instead of 2H MoS₂ because the simulations were completed before the experiments had confirmed the presence of 2H MoS₂. The MoS₂ atoms interacted with the water molecules via Lennard-Jones and Coulomb interactions. The MoS₂ partial charges came from Varshney et al. and the Lennard-Jones parameters came from Luan and Zhou with one exception: the Luan and Zhou force field was parameterized based on the water contact angle on 2H MoS₂, which ranged from about 70° to 90° depending on the condition of the surface, whereas the simulations used 1T MoS₂, which has a much smaller contact angle of about 28°. (Varshney, V. et al. Computational Materials Science 48, 101-108 (2010); Luan, B. Appl. Phys. Lett. 108, 131601 (2016); Kozbial, A., et al., Langmuir 31, 8429-8435 (2015); Acerce, M., et al., Nature Nanotechnology 10, 313-318 (2015).) Crucially, Zhang, Luan, and Zhou showed that the sulfur Lennard-Jones c parameter tunes the water contact angle linearly over a wide range, although not all the way down to 28°. (Zhang, L., et al., J. Phys. Chem. B 123, 7243-7252 (2019).) Their relationship was extrapolated to estimate the value of the sulfur Lennard-Jones ε parameter on 1T MoS₂. Note that the contact angle of 1T MoS₂ used for this extrapolation was different than the contact angle of ce-MoS₂ measured here (FIG. 13). While this difference in contact angle would affect the quantitative values of the diffusion constants and density profiles, it is not expected that it would affect the qualitative trends observed as a function of interlayer spacing. Lorentz-Berthelot combination rules were used for all the Lennard-Jones parameters, as dictated by the Luan and Zhou force field.

In simulations with acetate- and amide-functionalized MoS₂ sheets, the acetate and acetamide groups were modeled using the DREIDING force field. (Mayo, S. L. et al., J. Phys. Chem. 94, 8897-8909 (1990).) The acetate partial charges were taken from Minofar et al., which used the restrained electrostatic potential (RESP) method to compute the partial charges. (Minofar, B. et al. J. Phys. Chem. B 110, 15939-15944 (2006).) The acetamide partial charges were computed with the same approach, using Hartree-Fock theory with a 6-31G* basis set and the antechamber program to compute the RESP charges. (Frisch, M. J. et al. Gaussian 16 Revision A. 03. (2016); Wang, J., et al., Journal of Computational Chemistry 25, 1157-1174 (2004).) Since the acetate groups have a −1 charge, each one was accompanied by a sodium ion to keep the system charge neutral. The sodium ions were modelled with the Joung and Cheatham potential. (Joung, I. S. et al., J. Phys. Chem. B 112, 9020-9041 (2008).)

In the charged MoS₂ simulations, the excess charge was modelled by augmenting the partial charges of the sulfur atoms on the inner surfaces of the MoS₂ sheets. Since 1T MoS₂ is metallic, the excess charge was spread evenly over all the inner sulfur atoms. Charge neutrality was maintained by adding sodium ions, as in the acetate simulations. The partial charges on the sulfur atoms on the outside of the sheets were unchanged since there was only water on the inside of the channel, even though in the experiment the outer sulfur atoms would be equivalently charged due to the metallic nature of 1T MoS₂. Likewise, the acetate and acetamide groups were only placed on the inner side of the MoS₂ sheets, even though both sides were functionalized in the experimental system.

The simulation was periodic in all three dimensions. The simulation box was about 13×3×4 nm³ (FIG. 5A). The dimension in the z-direction changed as the interlayer spacing changed. The dimension in the x-direction changed slightly due to the way the system was constructed. The number of water molecules ranged from about 2500 to 3300 depending on the interlayer spacing. The MoS₂ sheets were 6 nm long in the x-direction and periodically replicated in the y-direction. Simulations were performed at integer values of the center-to-center S—S distance ranging from 7 Å to 14 Å. This corresponds to interlayer separations (center-to-center Mo—Mo distances) of 10.15 Å to 17.15 Å. Consequently, results in FIGS. 5C and 5E reported at an interlayer separation of 12 Å, for example, were from a simulation with an interlayer separation of 12.15 Å.

The system was held at a temperature of 298 K and a pressure of 1 atm using the Nosé-Hoover style algorithm of Shinoda, Shiga, and Mikami. (Nosê, S. Molecular Physics 52, 255-268 (1984); Hoover, W. G. Phys. Rev. A 31, 1695-1697 (1985); Shinoda, W., et al., Phys. Rev. B 69, 134103 (2004); Martyna, G. J., et al., J. Chem. Phys. 101, 4177-4189 (1994); Parrinello, M. et al., Journal of Applied Physics 52, 7182-7190 (1981).) The thermostat damping time was 0.1 ps and the barostat damping time was 1 ps. The system was only barostatted in the x-direction, and it was not barostatted based on the total pressure; instead, it was based on the pressure of the “bulk-like” water in the reservoirs. This avoided artifacts due to the exposed edges of the MoS₂ sheets in the x-direction. The region of “bulk-like” water was defined as the region further than 1.2 nm from the edge of the MoS₂ sheets. The pressure was computed in that region using the zeroth-order Irving-Kirkwood (local virial) approximation, which is valid in isotropic fluids. (Irving, J. H. et al., J. Chem. Phys. 18, 817-829 (1950).)

The dynamics were integrated using the velocity-Verlet algorithm. (Swope, W. C., et al., J. Chem. Phys. 76, 637-649 (1982).) The systems with unfunctionalized sheets used a 2 fs timestep and the acetate and acetamide functionalized systems used a 1 fs timestep, to accommodate the high frequency intramolecular bond and angle vibrations. The NH₂ moieties of the acetamide groups were held rigid using the SHAKE algorithm. (Ryckaert, J.-P., et al., Journal of Computational Physics 23, 327-341 (1977).) This avoided the need for an even shorter timestep or a multi-timescale integrator to handle the fast vibrations of the light hydrogen atoms.

All long-range Coulomb interactions were evaluated using the particle-particle particle-mesh algorithm of Hockney and Eastwood. (Hockney, R. W. et al., SIAM Review 25, (1966).) The simulations were performed using the LAMMPS simulation package modified so that the barostat acted on the pressure in the bulk region. (Plimpton, S. Fast parallel algorithms for short-range molecular dynamics. Journal of Computational Physics 117, 1-19 (1995).)

The systems with unfunctionalized sheets were equilibrated for 0.2 ns and the functionalized sheets were equilibrated for 0.6 ns because it took longer for the spaces between the functional groups to fill in with water. The equilibration of the systems could be evaluated by checking that the volume of the system had stabilized. Data was then collected for 1 ns to compute the mean squared displacement.

### Md Simulations: PMFs

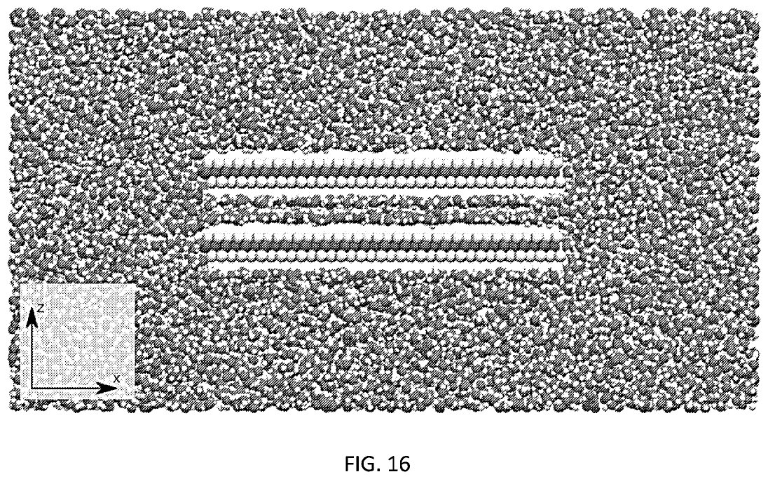

To compute the PMFs, biased simulations were performed over the range of relevant interlayer spacings. The difference in interlayer spacing between adjacent simulations ranged from 0.01 Å to 0.2 Å. The simulations were initialized from the unbiased simulation (used to compute the diffusion constant) with the closest interlayer spacing. These unbiased simulations were performed at 1 Å intervals of interlayer spacing, so each biased simulation was initialized no more than 0.5 Å from its bias center. After initialization, the WCA wall particles were removed, the z-dimension of the box was extended, and the empty space was filled with water molecules. This reduced interactions between periodic images of the MoS₂ sheets, which would be quite large at the initial z-dimension of about 4 nm. After this process, the final number of water molecules ranged from about 7100 to 8400, depending on the interlayer separation. After equilibration, this yielded simulation boxes with z-dimensions of about 7 Å. This means that for interlayer spacings of about 1-2 nm, the spacing between neighboring periodic images was 5-6 nm. A snapshot of the full periodic simulation box can be seen in FIG. 16. The MoS₂ sheets were then moved linearly to their designated interlayer spacing over the course of 20 ps.

A harmonic bias force was then applied to the interlayer spacing using the COLVARS package. (Fiorin, G., et al., Molecular Physics 111, 3345-3362 (2013).) The harmonic force constants ranged from 250 kcal mol⁻¹ Å⁻² to 2500 kcal mol⁻¹ Å⁻². Both the window widths and biasing potentials were adjusted iteratively and by hand to fully sample the relevant range of interlayer separations. The system was equilibrated with the bias force for 100 ps, and then the histogram of the interlayer separation was collected for 100 ps. The histograms were reweighted to compute the PMF using the Weighted Histogram Analysis Method. (Grossfield, A. WHAM the weighted histogram analysis method, version 2.0.9; Kumar, S., et al., Journal of Computational Chemistry 13, 1011-1021 (1992); Roux, B., Computer Physics Communications 91, 275-282 (1995).) The PMFs for the acetate- and acetamide-functionalized membranes were averaged over only two instances of the random placement of the functional groups, due to computational cost.

The internal degrees of freedom of the MoS₂ sheets were held rigid during the simulations. The body forces on the sheets in the x- and y-directions and the body torques on the sheets were all fixed to zero to prevent the sheets from sliding and rotating. Finally, the nonstandard barostat was the same as described above, except that the simulation was barostatted in both the x- and z-dimensions. All other simulation details were the same as in the unbiased simulations.

The MD force field was parameterized to faithfully reproduce water-water and water-MoS₂ interactions, but it was not designed to accurately model MoS₂—MoS₂ interactions. Force fields did exist that were parameterized based on bulk properties of MoS₂, but these were not well tested for applications in water-MoS₂ systems. The inventors' choice was appropriate for modelling the structure and dynamics of water in MoS₂ channels with fixed interlayer spacings, where the MoS₂—MoS₂ interactions were irrelevant. It is unclear, however, what effect this choice of force field may have on the PMFs presented in FIGS. 4A-4B, where the results might be more sensitive to the details of the MoS₂—MoS₂ interactions, especially at small interlayer spacings. To understand the effects of the inventors' choice of potential, the umbrella sampling calculations were repeated with all Mo—Mo, S—S, and Mo—S van der Waals (Lennard-Jones) interactions turned off (FIG. 17). The van der Waals interactions were more sensitive (compared to the Coulomb interactions) to the choice of potential, as well as the choice of contact angle used to parameterize the potential (see Supplementary Information section “MD simulations: diffusion constants and density profiles”).

Even with the MoS₂—MoS₂ van der Waals interactions entirely absent, the conclusions were qualitatively unchanged: ce-MoS₂ and acetate-MoS₂ both had global minima at 12.5 Å. In amide-MoS₂, the two minima were only separated by about 0.5 kcal mol⁻¹ (<1 k_{B}T), while the experimentally observed interlayer separation was at 9.9 Å. Adding any van der Waals interactions will stabilize the 10 Å minimum relative to the 12.5 Å minimum, breaking this bi-stability and making the 10 Å minimum the globally stable one. This demonstrates that these results are qualitatively robust to the choice of MoS₂ potential.

### Methods—Synthesis of MoS₂ Samples

First, 300 mg of MoS₂ powder (Sigma-Aldrich) was stirred with 3 ml of n-butyllithium for over 48 hours under an Ar atmosphere. The LixMoS₂ product was washed five times with hexane, transferred out of the Ar atmosphere and bath sonicated in 300 ml of water for 60 minutes. The resulting solution was dialyzed until the solution had a pH of ˜5 (several days). Finally, the solution was centrifuged for 15 min at 1500 rpm to remove any unexfoliated material. The final concentration of suspended flakes was on average −0.3 mg/ml.

Functionalization of the ce-MoS₂ was conducted in the liquid phase. A 20×molar excess of 2-iodoacetamide (Fisher Chemicals) or iodoacetic acid (Sigma-Aldrich) was stirred with ce-MoS₂ for five days. The solution was then washed 5 times with water via centrifugation and re-suspension, then centrifuged at 1500 rpm to remove aggregates and was sonicated at low power for about 20 minutes.

Membranes were fabricated by vacuum filtering a known quantity of MoS₂ solution through a mixed cellulose ester substrate with 25 nm pores (Millipore-Sigma), cut to shape and dried for a defined period before testing.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” can be mean only one or can mean “one or more.” Both embodiments are covered.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

1. A method of separating ions, molecules, or ions and molecules from a liquid sample containing ions, molecules, or ions and molecules using a molybdenum disulfide membrane comprising:
stacked molybdenum disulfide sheets; and
acetic acid groups, nitrile groups, or a combination thereof covalently bonded to the molybdenum disulfide sheets, the method comprising flowing the liquid sample through channels defined between the molybdenum disulfide sheets of the molybdenum disulfide membrane, whereby ions, molecules, or ions and molecules having sizes larger than the widths of the channels are prevented from flowing through the molybdenum disulfide membrane.

2. The method of claim 1, wherein the acetic acid groups are covalently bonded to the molybdenum disulfide sheets.

3. The method of claim 2, wherein the stacked molybdenum disulfide sheets have an interlayer spacing of at least 9.9 Å when the molybdenum disulfide membrane is dry.

4. The method of claim 2, wherein the molybdenum disulfide sheets have a degree of acetic acid functionalization of at least 10%.

5. The method of claim 4, wherein the molybdenum disulfide sheets have a degree of acetic acid functionalization in the range from 10% to 40%.

6. The method of claim 1, wherein the nitrile groups are covalently bonded to the molybdenum disulfide sheets.

7. The method of claim 1, wherein the liquid sample comprises water.

8. The method of claim 7, wherein the water is salinated.

9. The method of claim 1, wherein the liquid sample comprises anions having sizes larger than the widths of the channels.

10. The method of claim 1, further comprising drying the molybdenum disulfide membrane and then flowing a second liquid sample containing ions, molecules, or ions and molecules through the channels defined between the molybdenum disulfide sheets, whereby ions, molecules, or ions and molecules in the second liquid sample having sizes larger than widths of the channels are prevented from flowing through the molybdenum disulfide membrane.

11. The method of claim 1, wherein the ions, molecules, or ions and molecules having sizes larger than the widths of the channels comprise sodium ions.

12. The method of claim 2, wherein the ions, molecules, or ions and molecules having sizes larger than the widths of the channels comprise sodium ions.

13. A method of making a molybdenum disulfide membrane, the method comprising:
forming an aqueous suspension of exfoliated molybdenum disulfide sheets;
adding an organohalide compound comprising acetate groups or nitrile groups to the aqueous suspension, whereby the organohalide compound reacts with the molybdenum disulfide sheets to form molybdenum disulfide sheets that are covalently functionalized with acetate groups or nitrile groups;
filtering the aqueous suspension through a porous polymer substrate to form a supported membrane comprising stacked sheets of the covalently functionalized molybdenum disulfide sheets on the porous polymer substrate; and
delaminating the membrane from the porous polymer substrate.

14. The method of claim 13, wherein the organohalide compound is iodoacetic acid.

15. The method of claim 13, wherein the organohalide compound is an iodonitrile compound.
